(19) United States
(12) Patent Application Publication
(10) Pub. No.: US 2005/0062344 A1
(43) Pub. Date: Mar. 24, 2005

(54) Trailer locking system

(76) Inventors: John P. Holt, Fresno, CA (US); Gregory B. Moore, Buchanan, TN (US)

Correspondence Address: Richard A. Ryan;RYAN & ENGNATH, Suite 104, 8469 N. Millbrook, Fresno, CA, 93720, US

(21) Appl. No.: 10/690,256

(22) Filed: Oct. 20, 2003

Related U.S. Application Data
(63) Continuation-in-part of application No. 10/671,187, filed on Sep. 24, 2003.

(51) Int. Cl. B60T 13/00

(52) U.S. Cl. 303/7

(57) ABSTRACT

A locking system having a brake lock device for automatically immobilizing trailers to prevent unauthorized movement of the trailer and a door lock device for automatically locking the doors to prevent unauthorized entry into the trailer. The brake lock device vents compressed air from the brake line through a control valve connected to a controller unit. A keypad, transmits operational instructions to the controller unit. The door lock device has an electromechanical device, such as a linear actuator, connected to the controller unit to engage a receptor in or on a tubular frame member of the trailer to prevent the opening of the trailer doors. A position switch indicates the door status so the controller unit can automatically engage the locking mechanism. A radio in the controller unit permits wireless communication to report status and to allow central command control over the entire trailer locking system.

### CROSS-REFERENCE TO RELATED APPLICATIONS

This application claims the benefit of U.S. patent application Ser. No. 09/872,512 filed Jun. 1, 2001, now patented as U.S. Pat. No. 6,634,721 issued Oct. 21, 2003, and U.S. patent application Ser. No. 10/671,187 filed on Sep. 24, 2003.

### BACKGROUND OF THE INVENTION

A. Field of the Invention

The field of the present invention relates generally to systems for securing a trailer so as to prevent unauthorized movement of and entry into the trailer. More specifically, this invention relates to trailer locking systems that lock the trailer's air brakes to prevent movement of the trailer and utilize a computer-controlled electro-mechanical device to secure the doors. Even more specifically, this invention relates to such trailer locking systems that provide for remote operation and reporting via wireless transmission.

B. Background

Many persons utilize trailers for various applications, including the transport of consumer goods, food products, vehicles and many other materials. Although the trailers commonly used in the trucking industry are very expensive, the goods being transported therein, such as electronics or cars, can often far exceed the value of the trailer itself. While pulling a trailer, the truck driver often needs to leave the trailer unmanned at a specified location, typically after first disconnecting the trailer from the vehicle pulling the trailer. All too often, unfortunately, thieves utilize the opportunity of a trailer left alone, particularly if it is at a remote location, to steal the trailer and/or its contents. Once the thieves open the trailer doors, they will quickly remove its contents and leave the area. Due to the nature of the crime and the goods stored therein, it is often difficult for the owner of the goods to regain possession of his or her property, often including the trailer itself.

Unauthorized movement or use, including theft, of trailers and their cargo is a major concern among those in the trucking industry (overall, loss of cargo has an estimated annual business impact of $30 to $60 billion). In addition to carrying or storing general consumer goods, trailers are utilized all over the world to transport and store materials that are known to be desirable to terrorists, both domestic and foreign, and other individuals or groups that desire to harm others or acquire their property. These materials include explosive devices, chemicals, weapons, ammunition, parts for repairing weapons and materials for making or using explosives and weapons. Although some of this material is transported or stored under guarded conditions, much of it is not. Because of greater concern for national security and safety throughout the world, numerous governments, military, private companies and individuals are taking a more active role in addressing or regulating the security of trailers. Even trailers carrying items once thought to be relatively benign, such as those transporting food goods, are now facing increased security concerns and regulations due to the realization that such items can be easily and effectively contaminated with chemical or biological matter that could harm large numbers of people.

In light of the increased security risks and governmental oversight, unauthorized movement of and entry into trailers is a major concern among those in the trucking and cargo industries. As security devices become more complicated and more expensive, thieves become more sophisticated and more resourceful, making the protection of an unmanned trailer very difficult and expensive. While cars, trucks and other motorized vehicles require power control systems and steering mechanisms to operate, which can be disabled to prevent theft of the vehicle, trailers generally have no such systems or mechanisms. As a result, it is generally easier to disable (i.e., make it difficult to move or enter without authorization) a motorized vehicle than it is to disable a non-motorized vehicle, such as a trailer, that relies on the movement of another vehicle for its own movement. Devices have been developed that, when regularly and properly used, generally deter the would be thief from stealing a vehicle, such as an automobile or truck, in part because of the amount of time and effort it takes to remove or get around the theft deterrent device. An example of devices that have been generally successful at reducing theft of vehicles are the various steering wheel lock devices that provide a bar across the steering wheel, making movement of the steering wheel, and hence the vehicle, virtually impossible. The need to hook-up to and move trailers makes it very difficult to disable them so as to prevent theft. Naturally, this makes it difficult and/or expensive to obtain insurance to protect against loss of the trailer and its goods. While the steering wheel lock devices and other apparatuses have worked well for motorized vehicles such as automobiles and trucks, there exists a need for a system that prevents unauthorized movement of and entry into a trailer in order to protect the owner's investment in the goods stored therein and to prevent sensitive materials falling into the possession of dangerous individuals or groups.

To prevent unauthorized movement or theft of a trailer, trailer owners and operators typically use mechanical locking devices, such as the gladhand and kingpin locks, that are designed to physically prevent hook-up to those trailer components. To prevent the theft of materials from inside a trailer, trailer owners and operators typically use exterior mechanical locking devices, such as padlocks and the like, and seals that are designed to physically prevent entry into the trailer or container. As those in the trucking industry know, experience has proven that the devices currently in use can be overcome relatively easily by the determined and resourceful thief. In addition to being relatively easy to overcome, the standard locking devices are useless if the truck driver or operator (i.e., a person having authority to open the trailer to remove the contents or conduct an inventory check) forgets to set the locks. Even when the driver or operator does set the lock or locks, problems can arise if the next authorized driver or operator does not have the correct key or combination and is forced to break the lock to move or gain entry into the trailer, thereby rendering the security system useless. In areas where a number of people may need access to a trailer or its contents, the ability to ensure that the right person has the necessary key or combination to gain access to or entry into the trailer can be quite challenging.

Because trailers utilize compressed air-operated braking systems, theft deterrent devices have been developed that take advantage of that system. The typical trailer utilizes spring-biased parking brakes which require the introduction of air pressure to release the brakes. The parking brake system is configured such that the brakes are engaged by a spring to lock the trailer's wheels when there is no air pressure in the air line to release the brakes. The tractor or truck used to haul the trailer includes an air compressor that provides compressed air to the trailer through a brake air line in order to release the brakes so as to allow movement of the trailer. When the driver releases the trailer from the truck, the disconnect of the brake air line from the compressor biases the spring to lock the wheels to prevent movement of the trailer. Two such systems are described in U.S. Pat. No. 4,621,874 to Gustafsson and U.S. Pat. No. 5,145,240 to Harless, et al. The Gustafsson patent describes a vehicle theft device that utilizes a series of three-way valves and check valves to interact with the main and parking brake systems to prevent movement of a vehicle, primarily the tractor portion of a truck. The valves direct air pressure away from the drive axles and routes it to actuate the front brakes only. A major limitation with this type of device is that if there is a malfunction, then the front wheels can lock-up while the vehicle (and trailer) is moving. Vehicle accidents have resulted from such a malfunction. The Harless patent describes a valve assembly that interacts with a trailer's air brake system to prevent movement of the trailer until someone manually releases the valve from inside the trailer. This system is primarily designed to prevent injury to workers while loading the trailer.

Trailer door locking devices have been developed that utilize various interior components of the trailer door mechanism and structure to provide a more secure locking system for trailers. An example of such systems, is set forth in U.S. Pat. Nos. 5,755,126; 5,781,399; 5,806,355; 5,931,033; 6,047,576; and 6,049,448 all to Lanigan et al. and U.S. Pat. No. 5,934,116 to Moore. The Lanigan patents generally describe a security system for trailer and cargo container doors that utilizes a latching mechanism that interacts with the header inside the trailer or container to secure the door in a closed position. The Moore patent generally describes a locking apparatus for trailer doors that utilizes a locking member to engage a bar configured to transversely span across the interface of the trailer doors.

In order to be able to find a stolen trailer and, hopefully, the goods or materials carried therein, some trucking companies utilize satellite tracking devices attached to the truck and/or trailer that enable the trucking company or law enforcement personnel to track the movement of the trailer. Unfortunately, most satellite systems are very expensive and can be relatively easily disabled (i.e., with a screwdriver and hammer) due to the vulnerability of the antenna assembly. An example of a communication-controlled trailer locking system is set forth in U.S. patent Publication No. 2002/0121962 to Wolfe. This particular system controls access through the trailer doors depending on a combination of factors, including the location of the vehicle, its speed and its delivery status. If the trailer is not at the location where it is supposed to be or authorized to be, access to the trailer doors will be prohibited by an electromechanical device that cooperatively engages the trailer doors.

Although the various theft deterrent devices currently available have some ability to prevent theft of a trailer and/or the materials from inside the trailer, they have a number of disadvantages and limitations that generally prevent wide acceptance or effective theft deterrence. One of the most common problems with presently available trailer security devices is the need to rely on human operation to set or re-set the security device. What is needed is an easy to use and effective theft deterrent or locking device that allows a trailer owner or operator to quickly and securely lock the trailer in order to prevent unauthorized movement of and/or entry into the trailer. The preferred trailer locking system should automatically secure the trailer and lock the door, without the need for the human element to set the lock, and maintain the trailer and its doors in a locked condition until such time as an authorized individual provides a command to allow movement of or access into the trailer. The preferred system will also facilitate wireless communication for management control and reporting of the trailer status (i.e., locked/unlocked or open/closed) and remote operation of the trailer brake and door locking mechanisms.

### SUMMARY OF THE INVENTION

The trailer locking system of the present invention solves the problems identified above. That is to say, the present invention discloses a new and useful trailer locking system that effectively prevents unauthorized movement of a trailer and entry through the trailer doors. The trailer locking system of the present invention is adaptable to new and existing trailers, is easy for the truck driver or operator to engage and is difficult for the thief to overcome or disable. The trailer locking system of the present invention automatically engages the brake locking device when the parking brake is set and/or when the trailer is disconnected from the truck and the door locking device when the door is closed, and maintains the trailer and doors in the locked condition until an authorized person enters the proper unlock code.

In one aspect of the present invention, the brake locking system comprises a control mechanism, a computerized controller unit in communication with the control mechanism, a brake locking device to prevent unauthorized movement of the trailer, a door locking device to prevent unauthorized entry into the trailer and a communication system to allow remote management control and reporting of the trailer locking system. The controller unit is connected to a power supply, such as a battery, and adapted for connection to an external power source, such as the electrical take-off from the tractor or truck pulling the trailer. A charging regulator can be used to ensure the battery is kept in a charged condition without overcharging. In one embodiment, the battery is located in a housing that encloses the controller unit and the charging regulator is configured for recharging by the trailer electrical system. The control mechanism, which can be an electronic keypad mounted on the exterior of the trailer or a keylock, radio controlled or other similar mechanisms, is electrically connected to the controller unit for selectively controlling the brake locking device and door locking device. The communication system can include a radio, which can be located inside or outside the controller unit housing, and an antenna to allow communication between the controller unit and a remote or central location via satellite, cellular, radio or other types of wireless communication.

In a preferred embodiment, the brake locking device comprises a control valve mounted in the controller housing that is operatively connected to the controller unit and the trailer brake line. The inlet of the control valve inlet is connected to the trailer's supply of compressed air (i.e., the air supply system from the tractor or truck that connects via gladhand) and the outlet is in fluid communication, selectively, with the inlet so as to allow compressed air to vent from the control valve when it is desired to lock the trailer's brakes. The compressed air can vent to the inside of the housing or outside the housing. In a preferred embodiment, the control valve has a mechanism for activating the valve by selectively opening and closing the interior chamber between the inlet and the outlet. The activating mechanism can be an electric motor operatively connected to a shaft that is slidably disposed in the control valve. One or more limiting switches, electrically connected to the controller unit, are used to monitor and limit the movement of the shaft in the control valve. Pressure sensors are operatively engaged with the control valve and electrically connected to the controller unit. In another configuration of the present invention, the trailer locking device is configured for use with a trailer having an internal cavity such that the controller unit housing is disposed in the internal cavity of the trailer and the control mechanism is attached to an outer wall of the internal cavity. In yet another configuration of the present invention, the trailer locking system is incorporated into a trailer, such that the housing could be eliminated and the controller unit, power supply and control valve being incorporated into the trailer itself.

In a preferred embodiment, the door lock device comprises a linear actuator controlled by the controller unit to actuate a sliding bolt or other device into engagement with an actuator receiving mechanism and a position switch to indicate and transmit the open or closed position of the door. In the preferred embodiment, the linear actuator is attached to back plate member that is mounted on the inside of the trailer door. The actuator receiving mechanism, which can be a hole located in a trailer frame member, such as the header, is positioned and configured to receive the stainless steel bolt portion of the actuator mechanism. The position switch, which can be a reed switch having a pair of interacting magnets, one on the door frame and one on the locking mechanism or door, is used to indicate to the controller unit whether the door is in an open or closed position. If the position switch indicates an open door, the controller unit does not send a signal to the actuator to lock the door. The controller unit is configured to automatically lock the door, either immediately or after a pre-set amount of time, upon receiving a signal from the position switch that the door is closed. Because the controller unit is configured to automatically activate the linear actuator either immediately or after a preset elapsed time, it will relock the door even if the driver or other trailer operator forgets to set the lock.

Utilizing the trailer locking system of the present invention, the trailer brakes can be released or the door can be unlocked by entering the correct code on the keypad or by receiving a predetermined signal via wireless interface. The trailer locking system of the present invention allows the person exercising control over the contents of the trailer to prevent anyone, including the driver or other persons, from releasing the trailer brakes and/or opening the door by limiting access to the code. The controller unit can also be configured to receive code changes, by utilizing appropriate security level clearances, that would modify the existing code to disengage the trailer brakes and/or unlock the doors if it were necessary because the code had been compromised or if the trailer was being sent to a different receiving party than was originally intended (as a result, requiring a different code for the new receiving party).

Accordingly, the primary objective of the present invention is to provide a trailer locking system that provides the advantages described herein and overcomes the disadvantages and/or limitations associated with presently available trailer brake and door locking devices and systems.

It is also an important objective of the present invention to provide an easy to use and effective theft deterrent system that is difficult to overcome so as to prevent theft of a trailer or the materials from inside the trailer.

It is also an important objective of the present invention to provide a trailer locking system that has a controller unit configured to operate a brake lock device configured to selectively place the brakes in a stopped condition to prevent unauthorized movement of the trailer and a door lock device configured to selectively prevent unauthorized entry into the trailer through the trailer doors.

It is also an important objective of the present invention to provide a trailer locking system that has a controller unit operatively connected to a brake lock device configured to automatically lock the brakes by venting air through a control valve when the supply of compressed air is disconnected at the gladhand and operatively connected to a door lock device configured to automatically lock a door when the door is closed, or when a command to lock the brakes and/or the door is transmitted by a user through a keypad or over a wireless network.

It is also an important objective of the present invention to provide a trailer locking system that has a controller unit operatively connected to a brake lock device that prevents compressed air from getting to the air-operated brakes by utilizing a valve disposed between the source of compressed air and the brakes to vent the compressed air when locking of the trailer is desired and a door lock device that utilizes a linear actuator to drive a sliding bolt into a trailer frame member or a receiver mounted to the frame.

It is also an important objective of the present invention to provide a trailer locking system that is adaptable for new and retrofit installations at various locations on the trailer.

It is also an important objective of the present invention to provide a trailer locking system that can interact with other locking systems to automatically lock the brakes and doors, and maintain the brakes and doors in a locked condition until such time as the proper code is entered into the trailer locking system.

The above and other objectives of the present invention are explained in greater detail by reference to the attached figures and the description of the preferred embodiment which follows. As set forth herein, the present invention resides in the novel features of form, construction, mode of operation and combination of processes presently described and understood by the claims.

### BRIEF DESCRIPTION OF THE DRAWINGS

In the drawings which illustrate the best modes presently contemplated for carrying out the present invention:

FIG. 1 is a cut-away side view of a typical trailer showing one possible installation of the present invention;

FIG. 2 is a front view of the trailer in FIG. 1;

FIG. 3 is a schematic view of the components of the present invention;

FIG. 4 is an perspective view of the preferred embodiment of the brake locking device of the present invention;

FIG. 5 is a cut-away side view showing use of the invention with a trailer not having cavity between the outside and the interior bulkhead;

FIG. 6 is a cut-away side view showing use of the present invention with a flatbed trailer;

FIG. 7 is a perspective view of a control valve preferably suitable for use with the present invention;

FIG. 8 is a cross-sectional view of the control valve in FIG. 7;

FIG. 9 is schematic of the communication system suitable for use with a preferred embodiment of the present invention;

FIG. 10 is a front view of the door lock device of the present invention from inside a trailer or cargo container with the swing doors closed;

FIG. 11 is a side view of a preferred embodiment of the door lock device of the present invention;

FIG. 12 is a front view of the actuator mechanism and its related components mounted on the back plate member;

FIG. 13 is a front view of the actuator mechanism, controller unit and position switches of the door lock device of the present invention;

FIG. 14 is a front view of a keypad configured to operate with the trailer locking system of the present invention;

FIG. 15 is a front view of a keypad having a visual representation of the locked and unlocked doors;

FIG. 16 is a front view of a keypad configured to be separate from the trailer and engageable with the trailer locking system when used to operate the controller unit; and

FIG. 17 is a front view of the door lock device configured for use with a roll-up door from inside a trailer or cargo container having the roll-up door closed.

### DETAILED DESCRIPTION OF THE PREFERRED EMBODIMENTS

With reference to the figures where like elements have been given like numerical designations to facilitate the reader's understanding of the present invention, and particularly with reference to the embodiments of the present invention illustrated in the figures, the preferred embodiments of the present invention are set forth below. The enclosed figures and drawings are merely illustrative of the preferred embodiments and represent several different ways of configuring the present invention. Although specific components, materials, configurations and uses of the present invention are illustrated and set forth in this disclosure, it should be understood that a number of variations to the components and to the configuration of those components described herein and in the accompanying figures can be made without changing the scope and function of the invention set forth herein.

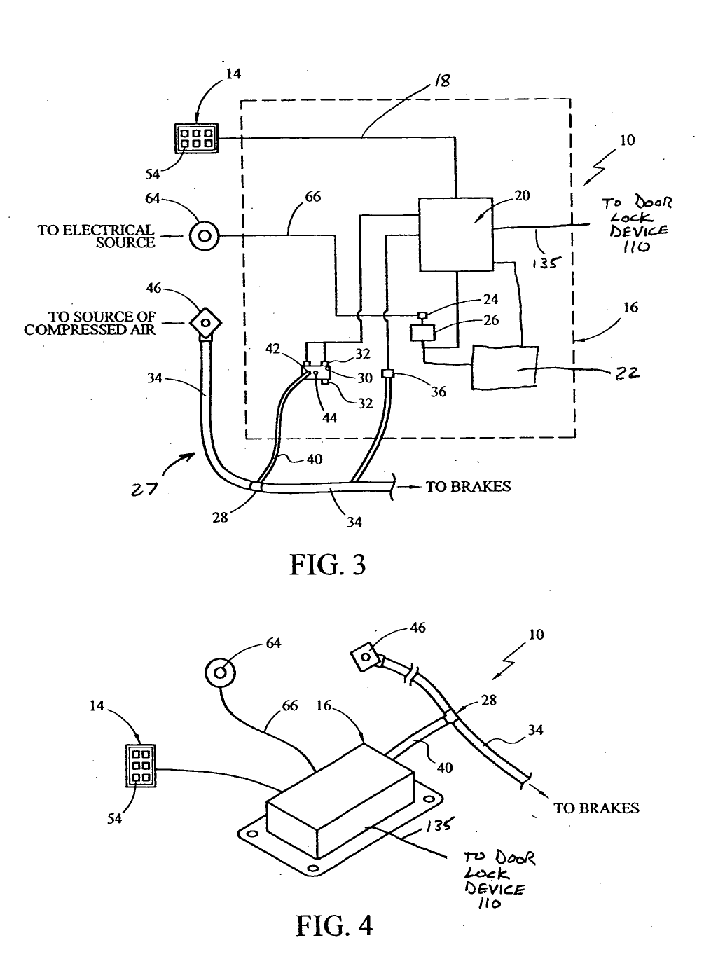

A preferred embodiment of the trailing locking system of the present invention, identified generally as 10 in the figures, is configured to function with a trailer 12 to prevent unauthorized movement of and/or entry into trailer 12. As is well known, such trailers 12 are commonly utilized in the trucking industry to move and store numerous types of materials, including consumer goods and sensitive or dangerous materials. In the preferred embodiment shown in the figures, trailer locking system 10 generally comprises control mechanism 14 operatively connected to controller unit 20 located inside controller housing 16, brake lock device 27, door lock devicel 110 and communication system 90. In the preferred embodiment, control mechanism 14 is an electronic keypad mounted on and accessible from the outside of trailer 12, as shown in FIG. 1 (as also shown in FIG. 1 and set forth in more detail below, housing 16 can be located inside the wall of trailer 12). Control mechanism 14 can also be a padlock dial type lock, key lock, radio controlled lock, card swipe type of lock or one of various other mechanisms suitable for controlling controller unit 20 (for purposes of this disclosure, control mechanism 14 is hereinafter referred to as keypad 14). Cable 18, such as coaxial cable, operatively interconnects keypad 14 with controller unit 20 inside controller housing 16. Alternatively, keypad 14 and controller unit 20 can connect by way of various other mechanisms known in the industry, including short range radio frequency devices such as infrared (IR) transmitters and receivers, the IEEE 802.11 (or Wi-Fi) based radio frequency standard and Bluetooth, a trademark owned by Bluetooth SIG, Inc. (a new wireless technology standard that utilizes the unlicensed 2.4 Ghz radio spectrum). Controller housing 16 can be made out of a variety of materials and, in the preferred embodiment, should have one or more vent holes or be otherwise sufficiently vented to vent discharge air (as described below). As shown in the schematic of FIG. 3, inside housing 16 is controller unit 20 having microprocessor board and associated electronic circuitry, wireless communication device 22, charging regulator 24, power supply 26 (i.e., battery), control valve 30 and one or more pressure or pneumatic sensors 32. Radio and electrostatic interference protection should be designed into controller unit 20 according to automotive safety standards. As described in more detail below, communication device 22 can be a radio or other device suitable for satellite, cellular, radio or other wireless communication and control valve 30 can be a solenoid actuated latching dump valve.

Brake lock device, shown generally as 27, of the preferred embodiment primarily comprises a splicing device 28, such as the T-splice shown in FIG. 3, control valve 30 and pneumatic sensors 32. As best shown in FIGS. 1 through 4 for typical trailer 12, brake line 34 interconnects gladhand coupler 46, which is located on the outside of trailer 12 and configured to receive compressed air from the truck or tractor used to haul trailer 12, and the trailer's braking system (not specifically shown). As best shown in FIG. 3, also connected to control valve 30 is inlet hose 40, which connects at one end to T-splice 28 disposed in pressure brake line 34 and at the opposite end to the inlet 42 of control valve 30. Also on control valve 30 is one or more outlets 44 for venting compressed air from control valve 30 to maintain the brakes in a locked condition (as explained in more detail below). In one configuration, outlet 44 vents air to the inside of housing 16 where the air can pass outside the housing 16 through vent holes or other venting mechanism (not shown). In another configuration, a discharge hose (not shown) can be used to connect outlet 44 with the exterior of housing 16 or the exterior of trailer 12.

One or more sensors 32 are operatively connected to control valve 30 and electronically connected to controller unit 20 to indicate whether there is compressed air in brake line 34 and, therefore, inlet hose 40. If any one of the sensors 32 determines that the pressure in brake line 34 is greater than a predetermined level (i.e., 60 psi, which is a typical minimum level needed to activate trailer brakes), then controller unit 20 will not open control valve 30, will not vent air through outlet 44 and, therefore, will not lock the trailer's brakes. This is a safety feature to prevent accidental locking of the trailer's brakes while trailer 12 is moving (i.e., being pulled by a truck). The sensors 32 are also used to automatically lock the trailer's brakes. Once the sensors 32 indicate to the controller unit 20 that the pressure in brake line 34 has dropped below the predetermined level, such as when the driver stops the truck or disconnects the air supply, then controller unit 20 signals control valve 30 to open and allow air to be vented through outlet 44, thereby preventing the trailer's brakes from being unlocked. If desired, a second sensor 36 can also be used to determine if compressed air is flowing in line 34 beyond T-splice 28 to the brake system. In one embodiment of the trailer locking system 10 of the present invention, housing 16 is sealed at the manufacturing stage to prevent unauthorized tampering and to prevent water, salt and other materials from entering housing 16 and possibly affecting or damaging the components located therein. The various components that are located inside housing 16 should be mounted or otherwise secured therein to prevent unwanted and possibly damaging movement of the components during transit of trailer 12.

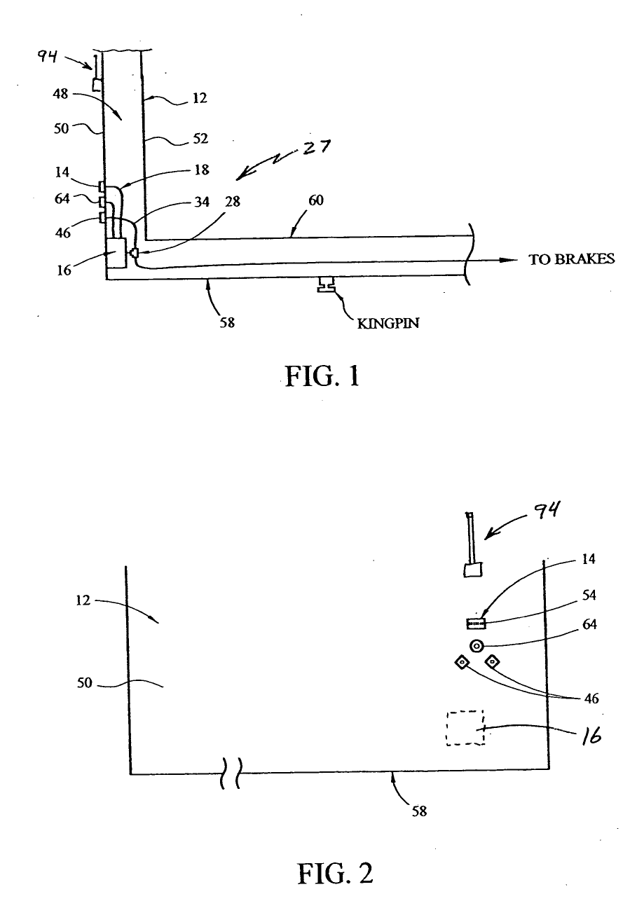

As shown in FIGS. 1 and 2, housing 16 is best placed inside the structural components of trailer 12 where it is inaccessible to a thief and protected from the environment. Many trailers 12 are constructed to have interior cavity 48 between the outer wall 50 and inner bulkhead 52. For these trailers 12, housing 16 can be installed in cavity 48 and keypad 14 is installed such that it faces outward from outer wall 50 so the keys 54 (for the keypad versions of control mechanism 14) can be accessed by the truck driver or other person needing to move trailer 12. Brake air lines 34, which connect to T-splice 28, are located between the deck plate 58 and the floor 60 of trailer 12 and travel rearward to connect to the trailer's brakes. In the configuration described above, housing 16 can be installed in cavity 48 by cutting an opening in deck plate 58 with a disk grinder or similar tool and then sealing the opening by welding or other known processes. Once installed, it would be very difficult for a thief to access housing 16 because use of a cutting torch or like equipment would likely result in cutting the brake lines 34 or inlet hose 40, which would have the affect of disabling the brake system altogether and preventing any movement of trailer 12.

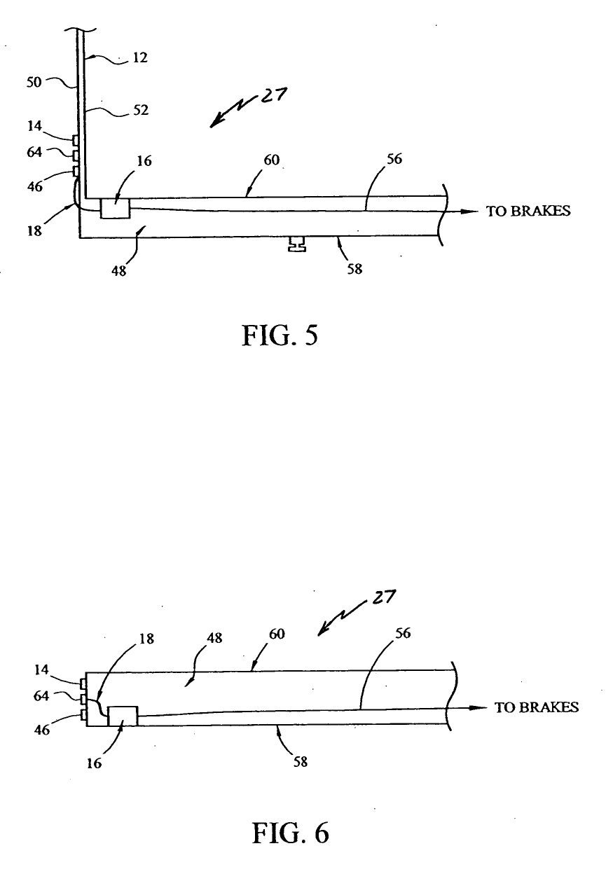

As shown in FIG. 5, for those trailers which are constructed such that they do not have cavity 48 at the front of the trailer 12, such as dry vans with no inner bulkhead and refrigerated trucks with externally mounted air lines, housing 16 can be installed in the interior cavity 48 between deck plate 58 and floor 60, with cable 18 located on the outside of outer wall 50. As shown in FIG. 6, flatbed trailers and the like will likely require the housing 16 to be installed in cavity 48 between deck plate 58 and floor 60 with cable 18 connecting to control mechanism 14 (i.e., keypad).

As shown in FIG. 3 and explained below, keypad 14 connects directly to controller unit 20 such that the proper numerical entry on keys 54 will unlock brake lock device 27 (by closing control valve 30) and allow trailer 12 to be moved. Electrical communication between keypad 14 and controller unit 20 is coded such that is not possible to “hot wire” the system, even if the potential thief can access the wires from keypad 14. Power coupling 64, which connects to the external electrical source (such as the power supply system on the truck or tractor), delivers power to charging regulator 24, via power supply line 66, to maintain battery 26 in a charged condition. Power from battery 26 operates system 10. Alternatively, for those trailers 12 that have their own power source (such as refrigerated trailers), power supply line 66 can connect to the trailer's power source. In this and similar configurations, it may be possible to eliminate battery 26. The air line 34 from gladhand coupler 46 connects to T-splice 28, which branches off to inlet hose 40, to deliver compressed air to valve 30 and to the air brakes on trailer 12. Sensor 32 connects to controller unit 20 so that the microprocessor therein can determine if coupler 46 is connected to the compressed air system of the truck or tractor. If the controller unit 20 receives a signal from sensor 32 that the compressed air supply line is not connected, it will open control valve 30 or lock it in an open position to prevent compressed air from being delivered to the brakes, thereby preventing movement of trailer 12.

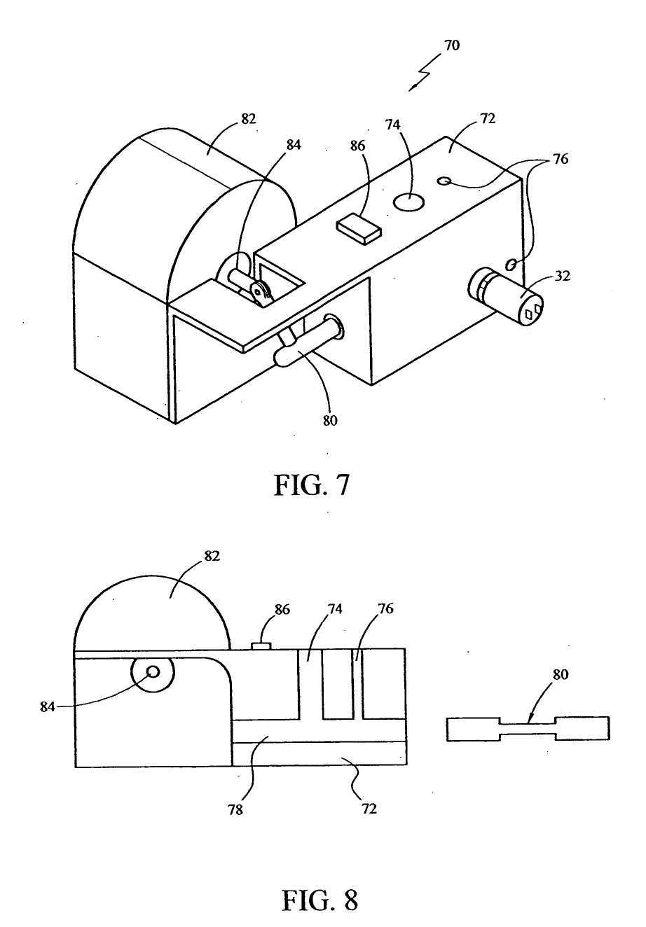

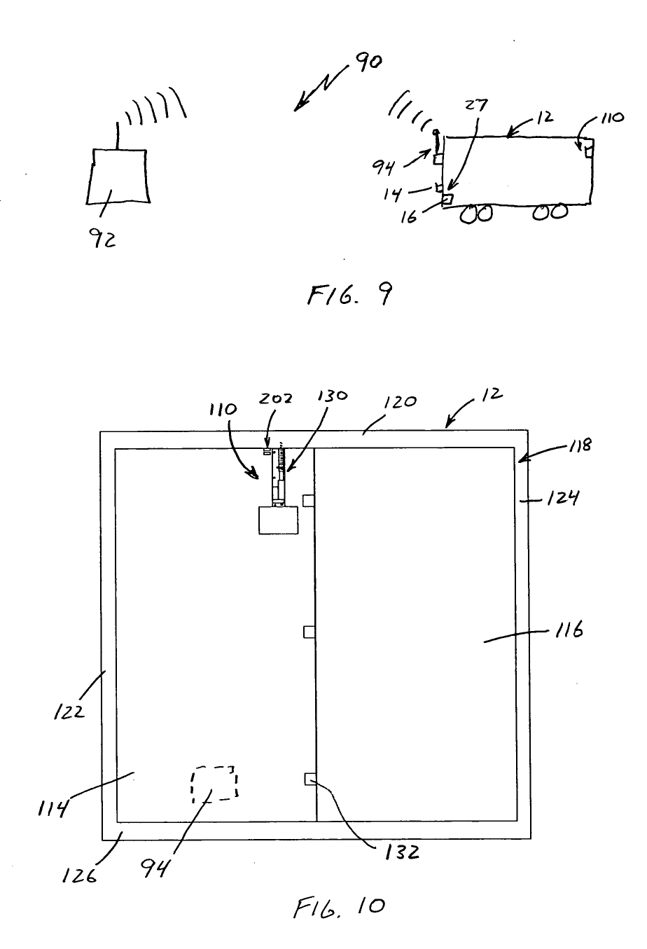

A number of different valves could be suitable for use as control valve 30. One particular control valve 30 that has been found to be particularly suitable for use with the present invention is shown in FIGS. 7 and 8 and is identified as 70 therein. Control valve 70 has valve body 72 with inlet 74, outlets 76 and interior chamber 78. Inlet 74 is configured to attach to inlet hose 40, which connects to brake line 34, and connect to chamber 78. Outlets 76 are in fluid communication with inlet 74 by way of chamber 78 so as to vent compressed air from valve 70 to prevent the trailer brakes from being released. Chamber 78 is configured to slidably receive shaft 80 therein. An activating mechanism, such as electric motor 82 is attached to valve 70 to move shaft 80 in chamber 78. Motor shaft 84 connects to an end of shaft 80 to slide shaft 80 in chamber 78. As the shaft 80 slides in chamber 78, the inlet 74 and outlets 76 are alternatively moved from being in communication with each other to where there is no communication between inlet 74 and outlets 76. Pressure sensors 32 attached to valve body 72 are used to monitor the pressure inside chamber 78. For back-up purposes, multiple pressure sensors 32 can be used (i.e., two are shown in FIG. 3). To monitor and limit the movement of shaft 80 inside chamber 78, one or more limiting switches 86 can be mounted on valve body 72 and connected to shaft 80.

The use of a microprocessor in controller unit 20 allows user-specific requirements to be programmed into system 10 to make it more functional for the particular driver, operator or trucking company using system 10. For instance, the microprocessor in controller unit 20 can be programmed to allow entry of a delay time or time function that locks the brakes for a specific amount of time (i.e., 8 hours) or automatically unlocks the brakes at a specific time of day and/or date (i.e., 7:00 a.m. on Monday morning). Microprocessor 20 can also be programmed to recognize different codes from different drivers so the trucking company can verify who has moved trailer 12 (and even when). For instance, system 10 can have a three tier code system where the driver's code and the amount of delay time can be modified only be a person having a management code, which code can only be modified by someone having the executive or top-level code. The factory can set the executive code (which can also be changed), allowing the purchaser to set and modify the management and driver codes.

As discussed above, trailer locking system 10 can utilize a mechanical locking device, such as a key lock, instead of the electronic keypad 14. The use of a key lock system reduces the dependence on electronics and the amount of electricity (battery) power required to operate system 10. In addition, the use of a key to unlock system 10 allows the trucking company or driver to control who can unlock system 10 (i.e., only a person with a key). As discussed above, however, the use of a key lock does have several disadvantages with regard to how easy it is to have a second driver unlock system 10 after the first driver sets system 10 in a locked condition. Another alternative keypad 14 is the use of a communication device 22 located in housing 16 or in connection with controller unit 20 that can receive a wireless transmission from a central location or from the truck or tractor pulling trailer 12. Various other control mechanisms 14 can be used. In addition, various control mechanisms 14 can be combined (i.e., keypad, key lock and radio) so as to provide increased security, redundancy or the ability to have a master override.

In another embodiment of the trailer locking system 10 of the present invention, brake locking device 27 can be incorporated into a trailer 12 without the use of any housing 16. When the trailer 12 is made, the controller unit 20, control valve 30 and power supply (battery 26) can be incorporated directly into the trailer 12, such as in an interior cavity 48. These components would have to be mounted to one or more of trailer walls. This eliminates the need for a separate housing 16 component. The control mechanism 14, such as keypad, could be mounted on the outside of the trailer wall and connect directly to controller unit 20, as described above. The control valve 30 and other components would operate the same as described above. In order for this embodiment to be practical, the various components would have to be sealed inside the trailer 12 and mounted so as not to break loose during movement of trailer 12.

In use, once trailer 12 is stopped and placed in a location where it is desired to be left until the next use, the driver sets the trailer's brakes, causing a drop in the air pressure in brake line 34. In the preferred embodiment of the present invention, the pressure sensors 32 constantly measure, with controller unit 20, the pressure in the brake line 34 to determine a measured pressure amount. When the measured pressure in brake line 34 drops below the predetermined pressure amount, the controller unit 20 signals the control valve 30 to open so that air will be vented through outlet 44, thereby automatically placing the trailer locking device 10 in a locked condition and preventing any movement of trailer 12 until the device 10 is placed in an unlocked condition. If someone without authorization attempts to hook-up to trailer 12, any compressed air delivered to brake line 34 will follow the path of least resistance and be vented out control valve 30 through outlet 44. The automatic locking by device 10 can be subject to any delay time (i.e., not automatically lock for 30 minutes to allow for a restroom or lunch break). In this manner, the operation of device 10 is not dependent on the truck driver remembering to set the controller mechanism 14 lock (code, key or etc.) after he or she disconnects from trailer 12. Alternatively, device 10 can be configured to require the driver or owner to manually operate keypad 14 to place the trailer locking device 10 in a locked condition. For instance, with a keypad system, a lock code would be entered on keys 54 of the keypad control mechanism 14 to send a signal to microprocessor 20 to open valve 30. As with the preferred automatic system, once in the locked condition, any compressed air that comes into the system (i.e., from an unauthorized hook-up) will be vented through outlet 44, preventing the air from passing through to the air brakes to unlock the trailer's brakes. When it is desired to move trailer 12, the truck driver can be provided with the proper code, key or etc. so that he or she may deactivate the trailer locking device 10. For keypad systems, there should be a sufficient number of keys 54 to prevent successful random guessing of numbers and not too many as to require the memorization of a complicated sequence of numbers. When the proper code is entered, the controller unit 20 sends a close signal to control valve 30 to close outlet 44, which allows compressed air to flow to the brakes, thereby releasing the brakes and allowing trailer 12 to be moved. To assist use at night and in inclement weather, the keypad or other device on controller unit 14 should be illuminated so that it can be seen and any operational or status indicators on keypad 14 can be read. As set forth herein, brake lock device 27 described above is utilized in conjunction with door lock device 110 to automatically lock the doors of trailer 12 to provide full security for trailer 12 and the contents therein.

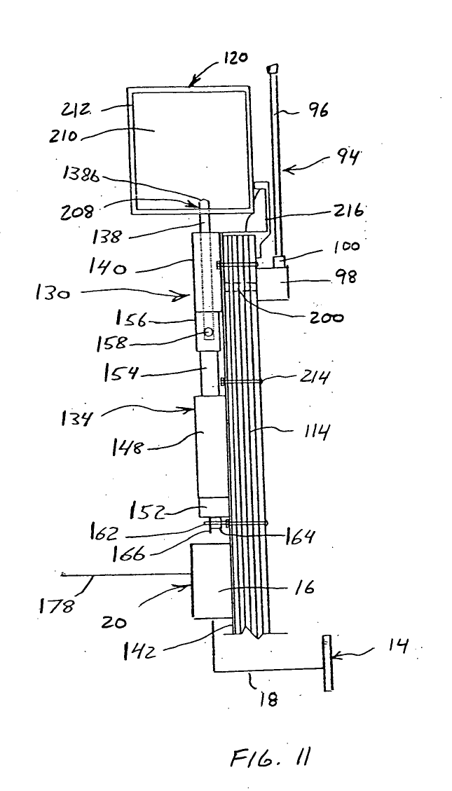

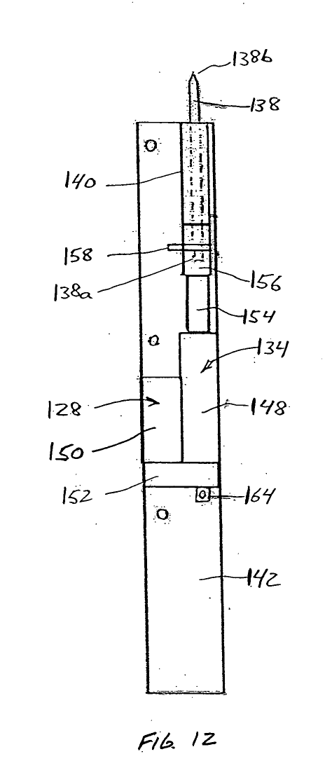

As stated above, communication system 90, shown in FIG. 9, can be configured to allow wireless communication between a command center 92, which can be a fixed or mobile location, and trailer locking system 10 to control and receive reports from controller unit 20 so as to allow remote operation and reporting of brake lock device 27 and door lock device 110. As shown in FIGS. 1, 2, 9 and 11, trailer locking system 10 can comprise antenna system 94 operatively connected to communication device 22, such as a radio or like device. Antenna system 94, shown best in FIG. 11 attached to door lock device 110, is used to improve the reception for communication device 22, which can be located inside housing 16 with controller unit 20, as shown in FIG. 3, so that trailer locking system 10 can be controlled or monitored remotely if desired. In the embodiment shown in FIG. 11, antenna system 94 comprises antenna rod 96 mounted on mounting box 98 by antenna adapter 100. The components for antenna system 94 should be selected to operatively correspond to communication device 22. For instance, if communication device 22 is a 900 MHz radio, then antenna system 94 should be a 900 MHz antenna so as to provide optimum performance for radio 22. Antenna system 94 can be of the type that communicates with a G.P.S. tracking unit located in the cab of a truck utilized to haul trailer 12. Instead of utilizing antenna rod 96 and the other external components, antenna system 94 can be configured to be internal to keypad 14 and included in the keypad wiring that connects to controller unit 20. In one configuration, antenna system 94 is a loop antenna disposed inside keypad 14, housing 16 or, if signal strength is or will not be a problem, inside controller unit 20 itself.

To obtain optimum security, brake lock device 27 described above is utilized with door lock device 110 to secure both the trailer 12 in place and prevent unauthorized entry into trailer 12. There are many different types of trailers 12 in use, many of which are configured to meet or exceed International Standards Organization (ISO) trailer requirements or other regulations pertaining to domestic trailer configurations. In one configuration, shown in FIG. 10, trailer 12 has a pair of swing-type loading doors 114 and 116 mounted on a structural frame 118 having a plurality of frame members, including top member or header 120 supported by side members 122 and 124 above bottom member or threshold 126. As shown in FIG. 17, trailer 12 can be configured with a single roll-up door 128 that is rolled or slid upward at the rearward opening of trailer 12. As shown in FIG. 10, which shows the view from inside trailer 12 with doors 114 and 116 closed, the door locking component 130 of door lock system 110 can be mounted on door 114 near header 120 to operatively engage header 120. Alternatively, door locking component 130 can be mounted on door 114 at or near threshold 126 to operatively engage threshold 126. In either configuration, door locking component 130 should be mounted generally near the center of header 120 or threshold 126 where doors 114 and 116 meet, as shown in FIG. 10. As shown, after door 116 is closed, door 114 closes to abut against the overlap plates 132 on door 116. As shown in FIG. 17, door locking component has a different configuration to prevent unauthorized entry into trailer 12 having roll-up door 128. In either configuration, as explained in more detail below, door lock device 110 is utilized with trailer 12 to prevent unauthorized entry into the interior storage compartment of trailer 12 through doors 114 and 116 or roll-up door 128.

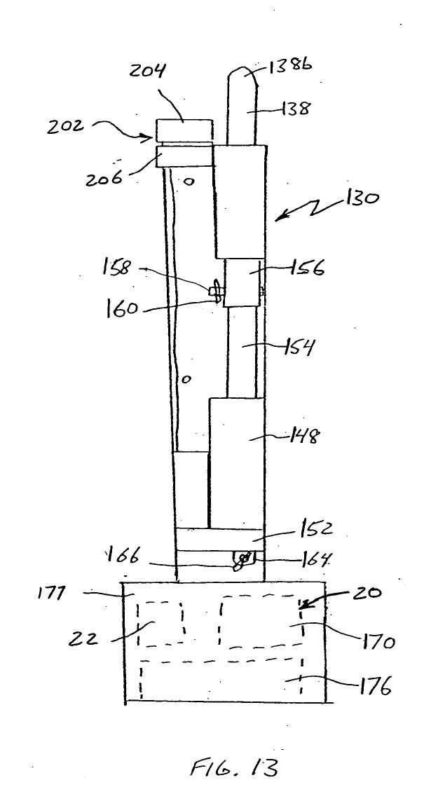

In a preferred embodiment of the door lock device 110 of the present invention, door locking component 130 primarily comprises an actuator mechanism 134 controlled by controller unit 20 and operatively connected thereto by cable or wire 135 to drive sliding bolt 138 slidably disposed in tubular member 140, all of which are mounted on or attached to back plate member 142, as shown in FIG. 11. Alternatively, as stated above with regard to keypad 14, actuator mechanism 134 can connect to controller unit 20 by a short range radio frequency device or other suitable devices. As set forth in more detail below, in one embodiment of the door lock device 110, controller unit 20 is operatively connected to antenna system 94. Keypad 14 is utilized for accessing controller unit 20 to engage or disengage door lock device 110, as shown generally in FIG. 2. In the preferred embodiment, actuator mechanism 134 is a electromechanical linear actuator having a main body 148 with a drive screw or other drive mechanism inside, a motor 150 to drive the drive mechanism and a gear box 152, as shown in FIGS. 11 and 12. Although other actuating systems can be used, including hydraulic, pneumatic or solenoid-based actuating systems, these systems have certain well known operational and functional disadvantages that make the electromechanical type of actuator mechanism 134 the preferred actuator. The drive mechanism inside main body 148 actuates actuating rod 154, which is coupled to sliding bolt 138 at collar 156 by first pin 158. In the preferred embodiment, collar 156 is welded or otherwise joined to first end 138a of sliding bolt 138. First pin 158 is placed through holes in sliding bolt 138, actuating rod 154 and collar 156 to couple these components together such that the actuation of actuating rod 154 by actuator mechanism 134 will cause sliding bolt 138 to move inside tubular member 140 along its longitudinal axis. In the preferred embodiment, first pin 158 is the type that cooperates with first spring clip 160, best shown in FIG. 13, to releasably maintain first pin 158 engaged with actuating rod 154, sliding bolt 138 and collar 154. Second pin 162, which in the preferred embodiment projects outwardly from a fixed position on back plate member 142, engages a hole in base extension 164 to hold actuator mechanism 134 in place on back plate member 142, as best shown in FIGS. 11 and 12. In the preferred embodiment, second spring clip 166, best shown in FIG. 11, is utilized to releasably maintain the coupling of second pin 162 with base extension 164.

As is known in the art, the typical linear actuator 134 has an actuating rod 154 that is threaded inside main body 148 to permit linear adjustment of the distance which actuating rod 154 extends. Use of first pin 158 prevents undesirable rotation of actuating rod 154, which could cause actuating rod 154 to become unthreaded inside main body 148. Use of spring clip 160 with first pin 158 allows a person who is inadvertently closed inside locked trailer 12 to remove first pin 158 and, as explained more fully below, uncouple actuator mechanism 134 from the other components so the doors 114 and 116 can be opened. Use of second pin 162 further facilitates the removal of actuator mechanism 134 from back plate member 142 in case of a person stuck inside trailer 12. In the embodiment shown in the drawings, a person inside locked trailer 12 would first remove second spring clip 166 from second pin 162 and pull actuator mechanism 134 at extension 164 away from back plate member 142 and off of second pin 162. The person then could remove first spring clip 160 from first pin 158 and uncouple first pin 158 from actuating rod 154, sliding bolt 138 and collar 156. Actuator mechanism 134 could then be lowered to remove second end 138b of sliding bolt 138 from engagement with header 120 (as explained below). To facilitate this operation, first spring clip 160 and second spring clip 166 can be of the quick-release type commonly utilized in various connecting operations.

As best shown in FIGS. 11 and 13, controller unit 20 can be mounted to the front side of back plate member 142 and connected to brake lock device 27 by appropriate mechanisms (i.e., wire 135). As shown, controller unit 20 is best enclosed in housing 16 to protect the computer circuitry and componentry, shown as integrated circuit board 170 on FIG. 13, for controller unit 20 to read and analyze incoming signals from various components of brake lock device 27 and door lock device 110 so as to lock or unlock brake lock device 27 and door lock device 110. Preferably, housing 16 sealably encloses controller unit 20 to prevent intrusion of water or other fluids that could damage the computer circuitry and componentry 170 (i.e., integrated circuit) and other components therein. Controller unit 20 is in communication with keypad 14 such that operation of keypad 14 can control the locking and unlocking by door locking component 130. In the embodiment shown in the figures, keypad 14 connects to controller unit 20 by keypad wire 18. Other known mechanisms of connecting keypad 14 to controller unit 20 can be utilized. In the preferred embodiment, controller housing 16 also encloses a radio or other communication device, shown as 22 in FIG. 13, to permit wireless radio communication with a remote central office (i.e., via a cellular communications network or satellite connection) or even to a hand-held radio device placed near trailer 12. In one embodiment, communication device 22 is a 900 MHz, 32 bit encryption radio. The preferred embodiment of the door lock device 110 of the present invention also has a rechargeable battery 176 located separately at door locking component 30, preferably in a sealed compartment 177, so it cannot damage the other components, and operatively connected to the electrical system of trailer 12, by battery wire 178 in FIG. 11, to allow recharging of battery 176 by the electrical system of trailer 12 or the vehicle pulling trailer 12. As shown in FIGS. 10 and 13, housing 16 will generally need to be somewhat larger size to accommodate battery 176 therein. In some situations, it may be possible to utilize solar panels or similar devices to create a recharging system to allow use of battery 176 in door lock device 110 when used with trailers 12 not having an available recharge system. In one configuration, sealed compartment 177 is used as housing 16 for controller unit 20.

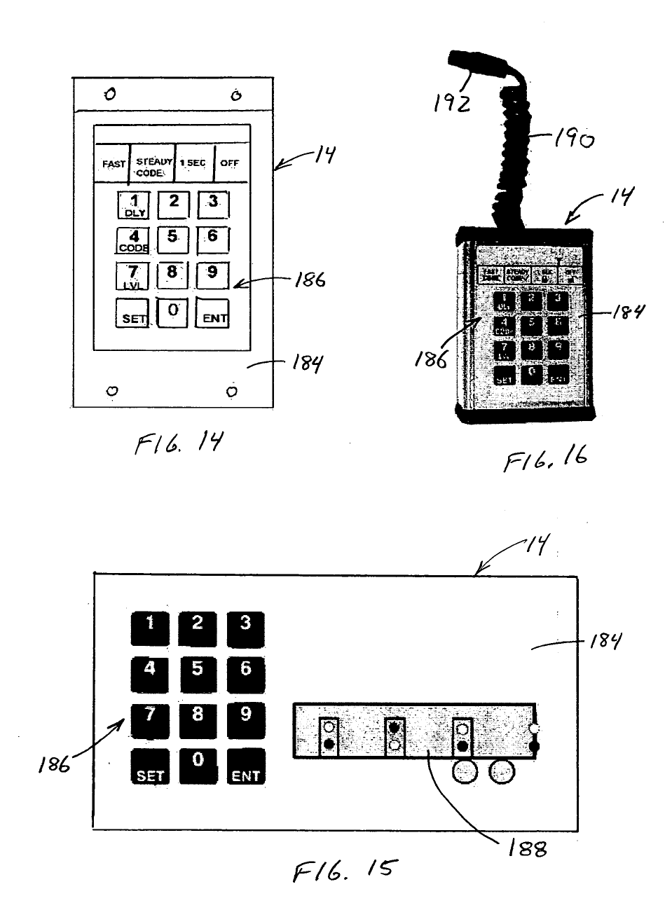

On the exterior of trailer 12 is placed electronic keypad 14, which is shown in detail in FIG. 14, to allow authorized persons to lock or unlock door lock device 110 to open doors 114 and 116. As stated above, keypad 14 can connect to controller unit 20 via keypad wire 18 and be located on door 114, as shown in FIG. 10, or other places at the rear of trailer 12. Alternatively, as described above with regard to brake lock device 27, keypad 14 can be placed at the front end of trailer 12, as shown in FIG. 1. This location may be particularly beneficial when door lock device 110 is used in conjunction with a brake lock device 27 for preventing unauthorized movement of trailer 12. Keypad 14 comprises a keypad case 184 having a plurality of function keys 186, such as the numeric and command keys shown in FIG. 14, sufficient for secure operation of controller unit 20. In the preferred embodiment, keypad 14 is securely mounted to trailer 12 to prevent keypad 14 falling off during transit or being easily removed by unauthorized persons. If desired, keypad 14 can be configured with a visual representation 188 of the locked/unlocked status of the various doors on trailer 12, as shown in FIG. 15. Different colored lights can be utilized to signal locked and unlocked conditions of the various doors. This could be particularly important when trailer 12 is utilized to transport different types (i.e., frozen, refrigerated and dry goods) of food materials. Once loaded into different compartments that are securely separated inside trailer 12, governmental regulations prohibit more than one door being open at any given time to avoid contamination of the food materials. Failure to abide by these regulations can result in significant fines and the intended recipient refusing to take the food materials. The keypad 14 of FIG. 15 lets the user know at a glance which, if any, doors are unlocked. If placed at front end of trailer 12, the keypad 14 of FIG. 15 can be seen in the driver's rearview mirror while trailer 12 is in transit.

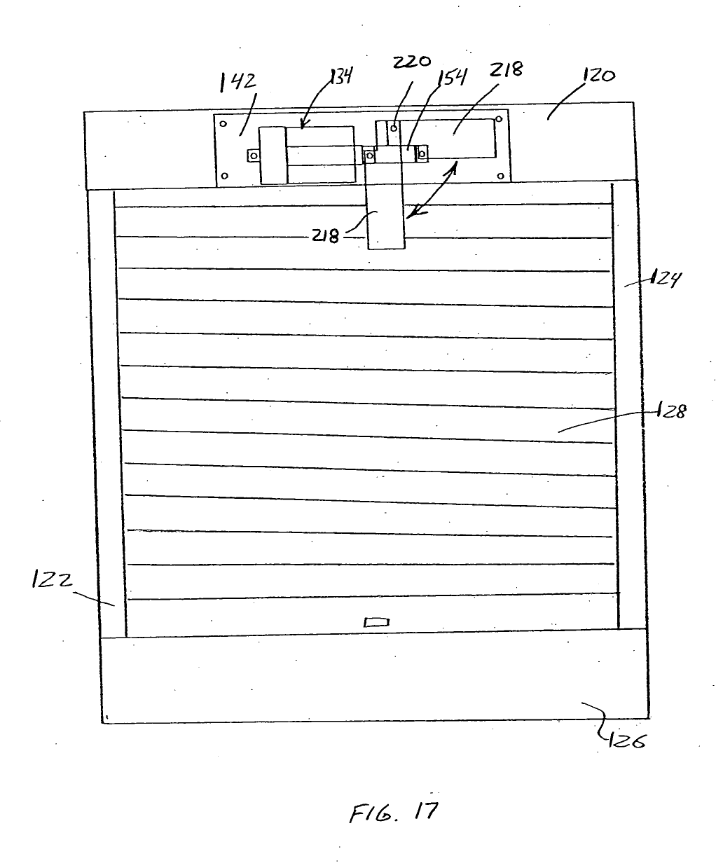

In another embodiment of keypad 14, shown in FIG. 16, the keypad 14 can be a portable device that has cord 190 with connector 192 at the end thereof that is adapted to connect to a like-configured port (not shown) on trailer 12. In another configuration, keypad case 184 can enclose a battery (not shown) to operate actuator mechanism 134. This embodiment is particularly useful when door lock device 110 is utilized with a trailer 12 that does not have its own electrical system or is not connected to another electrical system so as to recharge battery 176 inside sealed unit 177. In yet another embodiment, keypad 14 can include a separate computer componentry to allow it to store and analyze data and a display panel to display that information. For instance, such a keypad 14 can be utilized for inventory purposes. Every time someone opens doors 114 and 116 to add material in trailer 12 or remove material from trailer 12, he or she can enter the amount of material (i.e., ammunition or explosive devices) being removed from trailer 12. In this manner, the inventory of material inside trailer 12 will be known, particularly to persons remote from trailer 12, which can be accomplished by transmitting such information from communication device 22 via a wireless network.

The preferred embodiment of door lock device 110 of the present invention further comprises a position switch 202, as shown in FIGS. 10 and 13, in communication with the computer circuitry 170 to indicate the open or closed position of door 114. A variety of position switches 202 may be employed for communicating the position of door 114 to the integrated circuit 170. As explained in more detail below, door lock device 110 of the present invention utilizes information pertaining to the position of door 114 to operate actuator mechanism 134 so as to operatively engage sliding bolt 138 with header 120. In the preferred embodiment, position switch 202 is a reed switch having a first magnet 204 mounted to frame 118, such as to header 120 or threshold 126 as the case may be, and a second magnet 206 mounted to door locking component 130, such as on back plate member 142, so as to swing open and close with door locking component 130 as door 114 is opened or closed. As is well known in the art, a magnetic field between magnets 204 and 206 is employed to open and close connections to leads of integrated circuit 170. Other types of proximity types of switches can be used to determine the opened or closed position of door 114 to open or close a connection to integrated circuit 170, including various traditional contact mechanisms, so as to cause controller unit 20 to operate actuator mechanism 134. Although it is preferred that position switch 202 be located on or near door locking component 130, position switch 202 could be located away from door locking component 130 (i.e., at threshold 126 if door locking component 130 at header 120, or vice-versa).

In the preferred embodiment, back plate member 142 is made out of steel or other durable and strong material. Tubular member 140 can made from a steel tubular material and machine welded or otherwise fixed to back plate member 142. Second pin 162 can extend from the back side of back plate member 142 through back plate member 142 to extend frontwardly, as shown if the figures. Housing 16 for controller unit 20 can be bolted, welded or otherwise attached to back plate member 142 (if not placed at the front of trailer 12 or inside interior chamber 78). As stated above, main body 148 of actuator mechanism 134, actuating rod 154, collar 156 and sidling bolt 138 can be removably attached to second pin 162 and slidably received inside tubular member 140. In one configuration, sliding bolt 138 is a ¾″ stainless steel bolt and tubular member 140 has an inside diameter of ⅞″ to allow sliding bolt 138 to be slidably disposed therein and to move with out substantial interference from tubular member 140. To prevent door 114 from being opened, sliding bolt 138 is configured to engage a receptor 208 in or mounted to header 120 or threshold 126. In the preferred embodiment, as shown in FIG. 11, receptor 208 is a hole drilled or otherwise provided in header 120 that is sized and configured to slidably receive sliding bolt 138 inside chamber 210 of the tubular frame 212 of header 120, which can be a 4″ by 4″ square tubular member. In one configuration, the top of door locking component 130 is positioned approximately one inch below the bottom of header 120, by mounting back plate member 142 to door 114, and sliding bolt 138 has an actuating distance of approximately two inches, such that approximately one inch of second end 138b of sliding bolt 138 is received inside chamber 210 of tubular frame 212 of header 120 (or threshold 126). If desired, depending on the desired amount of security necessary, the amount of sliding bolt 138 received inside chamber 210 can be increased or decreased. Back plate member 142 can be mounted to door 114 using a plurality of bolts, such as carriage bolts 214, that pass through door 114 and back plate member 142. As known to those skilled in the art, a variety of other connection mechanisms and devices are also suitable for connecting back plate member 142 to door 114. Upper bracket 216, currently utilized by most trailers 12, prevents external access to sliding bolt 138.

In operation with door locking component 130, position switch 202, keypad 14 and antenna system 94 mounted in place, the locked position (as shown in FIG. 11) has second end 138b of sliding bolt 138 disposed through receptor 208 inside chamber 210 of tubular frame 212 of header 120. As such, door 114, and consequently door 116, cannot be opened. In order to open doors 114 and 116, an authorized person enters the appropriate code on keypad 14 to cause controller unit 20 to operate actuator mechanism 134 to cause actuating rod 154 to move downward. Because of the connection at collar 156, sliding bolt 138 is also moved downward such that second end 138b thereof is no longer engaged in or through receptor 208 into chamber 210. Once sliding bolt 138 is free of header 120, doors 114 and 116 may be swung open. In the preferred embodiment, integrated circuit 170 includes or is connected to a timer that will automatically operate actuator mechanism 134 after a preselected amount of time to move sliding bolt 138 upward into engagement with receptor 208 in or attached to header 120. This feature is particularly useful if someone unlocks door lock device 210 but is called away or otherwise does not open door 114 within the preset time period. To prevent sliding bolt 138 moving upward when door 114 is open, integrated circuit 170 will only move sliding bolt 138 into locking engagement if position switch 202 indicates that door 114 is closed. If position switch 202 indicates door 114 is closed and the preset time on the timer expires, then integrated circuit 170 of controller unit 20 will send a command to actuator mechanism 134 to move sliding bolt 138 into engagement with receptor 208 at or in header 120. If door 114 is open, as indicated by position switch 202, when the preset time on the timer expires, integrated circuit 170 will not send a command to actuate sliding bolt 138. As soon thereafter that position switch 202 indicates to controller unit 20 that door 114 is closed, integrated circuit 170 will send the command to acuate sliding bolt 138 to engage it in receptor 208 in header 120. In this manner, controller unit 20 will automatically engage door lock device 210 to lock door 114, thereby eliminating the need for the driver or operator to remember to engage door lock device 210 after closing door 114. This will eliminate unlocked doors 114 and 116 or 128 caused by human error due to forgetting to lock doors 114 and 116 or 128. In addition to being used to automatically lock or prevent locking of door 114, position switch 202 is utilized to report the status, open or closed, of door 114 to remote locations. When used with wireless communications, door 114 can be locked or unlocked remotely.

Information pertaining to the opening and closing of door 114 can be stored inside controller unit 20 and/or sent over a wireless network to the remote location, including transmissions on a real time basis. In this manner, oversight of access to the interior of trailer 12 can be maintained, thereby reducing the likelihood of unauthorized access to the contents inside trailer 12 by “insider” persons who otherwise have the codes and authority to operate keypad 14. This should significantly reduce the likelihood of employee or related party theft of materials from trailer 12. When used with G.P.S. and like systems (i.e., a 911 based location system), a central command center will be able to determine if a trailer 12 is where it is supposed to be and if someone is accessing the materials stored therein. Depending on the materials being transported or stored in trailer 12, immediate action can be taken to prevent the unauthorized removal or theft of the material.

The door lock device 110 of the present invention allows the person exercising control over the contents of trailer 12 to prevent anyone, including the driver, from opening door 114 by limiting access to the correct code. Keypad 14 can also be configured to receive code changes, by utilizing appropriate security level clearances, that would modify the existing code to unlock the system 10 if it were believed the security code had been compromised or if trailer 12 was being sent to a different receiving party than was originally intended (as a result, requiring a different code for the new receiving party). As discussed above, the door lock device 110 of the present invention can be configured to interact with a satellite or cellular telephone system and a GLS/G.P.S. system such that it will transmit a signal if door 114 is opened without the proper code being entered and identify the location of trailer 12. Door lock device 110 can work with a brake lock device 27 configured to prevent unauthorized movement of trailer 12. When door lock device 110 is used In conjunction with brake lock device 27, a would be thief is prevented from moving trailer 12 from its designated location, which makes theft of materials from inside trailer 12 much more difficult on the thief when he or she cannot easily open doors 114 and 116 due to door lock device 110. As is well known, time is generally one of the primary means of discouraging a thief. If the thief is bold enough to attempt to break into trailer 12 where it sits, door lock device 110 will make this difficult and, if it happens, will transmit a signal indicating an unauthorized entry into trailer 12 to a central location or police station.

In addition to the safety feature regarding persons inadvertently locked inside of trailer 12, which can be caused by accidently closing door 114 when someone inside (i.e., wind blowing, etc.), door lock device 110 is configured to prevent a broken or missing position switch 202 from causing door 114 to be stuck in a locked condition. Integrated circuit 170 is configured such that information from position switch 202 is not required to send a command to actuator mechanism 134 to disengage sliding bolt 138 from receptor 208 to open door 114. An open command can be sent at any time from controller unit 20. As such, if position switch 202 becomes damaged during loading or unloading materials into or from trailer 12 or if it breaks during transit, the driver, operator or other authorized person can still open door 114 by entering the correct code at keypad 14. Naturally, if position switch 202 is damaged, door lock device 110 will not be able to be relocked, which prevents door 114 being placed in essentially a “stuck” locked condition.

Various modifications to the door lock device 110 are possible. For instance, instead of having second end 138b of sliding bolt 138 engage a hole in header 120 or threshold 126, a separate receptor 208 can be mounted on or attached to header 120 or threshold 126. The hole drilled into header 120 or threshold 126 is preferred because it does not interfere with the ingress and egress of materials from trailer 12 and is significantly less likely to be damaged than a separate component. If desired, depending on the environmental conditions in which trailer 12 is or will be utilized, a cover (not shown) can be placed over all or part of actuator mechanism 134 to prevent dirt, dust and other debris or fluids from contacting the covered components.

In another embodiment, shown in FIG. 17, instead of actuating sliding bolt 138 along a straight linear path into receptor 208, actuator mechanism 134 is utilized to pivot tongue 218 so as to block the roll-up path of roll-up door 128. As shown in FIG. 18, the linear movement of actuating rod 154 acts on tongue 218 so as to pivot it around pivot connector 220. Tongue 218 is shaped and configured to pivotally react when actuating rod 154 is extended outward or drawn into main body 148 of actuator mechanism 134. As shown, back plate member 142 is mounted to the inside wall of header 120 such that tongue 218 is pivoted from a down position that blocks the movement of roll-up door 128 to an up position along back plate 142 and header 120 that allows roll-up door 128 to be rolled along the tracks inside trailer 12. With tongue 218 facing downward in the down position any upward movement of roll-up door 28 is prevented, thereby keeping roll-up door 128 in a closed position. The remaining components for door lock device 110 of this embodiment can be the same as described above for swing doors 114 and 116.

As stated above, trailer locking system 10 can be controlled remotely via satellite or cell network or any type of radio communication. Remote control communication system 90 can be of any configuration or design (such as any G.P.S. system on the market) and can be located in a single housing 16 with the brake lock device 27 and/or door lock device 110, or separately on the vehicle in a different housing and connected to the trailer locking system 10 via a hard-wired interface or a short-distance wireless interface. The purpose of this is to allow remote management of the control codes of this system 10 and of trailer 12 equipped with system 10 by the company or entity that is responsible for, or owns, or has an interest in, the vehicle that system 10 is installed on. Trailer 12 equipped with system 10 can thus be controlled from a remote location as to whether it will be allowed to move (by allowing the brakes to release) from a stationary position, and/or be brought to a stop while in motion (by remotely causing the brakes to apply). Controller unit 20 of trailer locking system 10 can be configured such that one code both closes control valve 30 to allow the trailer's brakes to be released so trailer 12 can be moved and unlocks doors 114 and 116 or roll-up door 128. Likewise, controller unit 20 can be configured such that one code, which can be the same code, both opens control valve 30 to place the trailer's brakes in a locked condition and locks doors 114, 116 or 128 to secure trailer 12 in place. The code used to secure the brakes of trailer 12 can be set to open doors 114, 116 or 128 to allow unloading of cargo from inside trailer 12. Alternatively, a combination of different codes can be used to perform separate or combined operations, such as locking/unlocking brakes and locking/unlocking one or more of the doors 114, 116 and 128. As known to those skilled in the art, controller unit 20 can be configured to operate as desired by the owner/operator of trailer 12 on which trailer locking system 10 is utilized.

Trailer locking system 10 can be configured so that any or all commands entered at keypad 14 overrides any or all commands entered remotely via satellite or cell network or any type of radio communication. Alternatively, trailer locking system 10 can also be configured so that any or all commands entered remotely via satellite or cell network or any type of radio communication overrides any or all commands entered at keypad 14. Also in the present embodiment, if commands are being entered simultaneously via satellite or cell network or any type of radio communication and at keypad 14, the control circuit will disregard all input received from the keypad 14. This is primarily to prevent confusion in the control circuit if it was receiving commands over the airwaves, which can take up to several minutes to complete, and also via keypad 14 (for instance if the driver or other personnel is entering commands while unaware that the system 10 is receiving commands remotely). Also in the trailer locking system 10 of the present embodiment, any and all commands entered at keypad 14, except unlocking, and any and all commands entered remotely via satellite or cell network or any type of radio communication, except unlocking, that are received by the controller unit 20 are acknowledged with an outgoing signal via satellite or cell network or any type of radio communication confirming that commands were in fact received and properly executed. For example, if any code is changed manually at keypad 14, controller unit 20 will send this information to the headquarters or other remote control center 92. Also, if any codes are changed via satellite (or airwaves), the controller unit 20 will acknowledge that the commands were received and/or properly executed by responding (i.e., by returning an acknowledgment signal) to control center 92. In addition, all unlocking events, such as date/time/duration, can be recorded onboard by the controller unit 20, which has it's own chronometer, and can be retrieved via airwaves on command or automatically sent at predetermined intervals (i.e., once every 30 days). Naturally, controller unit 20 can be configured to process, record and store any information desired by the user of trailer locking system 10 desired.

While there are shown and described herein certain specific alternative forms of the invention, it will be readily apparent to those skilled in the art that the invention is not so limited, but is susceptible to various modifications and rearrangements in design and materials without departing from the spirit and scope of the invention. For instance, it should be noted that the present invention is subject to modification with regard to the dimensional relationships set forth herein and modifications in assembly, materials, size, shape and use. For example, while a certain computer, electronic and radio devices and materials have been used in the embodiments of the invention set forth above, other such devices and materials could also be used. Therefore, it is contemplated that the appended claims will cover any modifications or embodiments as fall within the true scope of the invention.

1. A trailer locking system for securing a trailer having a door and a braking system, said braking system having a brake line configured to pneumatically interconnect a supply of compressed air to one or more air-operated brakes on said trailer, said trailer locking system comprising:
a power supply;
a brake lock device in operative communication with said braking system, said brake lock device configured to selectively place said brakes in a locked condition and prevent movement of said trailer;
a door lock device in operative communication with said door, said door lock device configured to selectively prevent the opening of said door when said door lock device is in a locked condition;
a controller unit connected to said power supply and in operative communication with said brake lock device and said door lock device, said controller unit having computer circuitry and componentry configured to control the operation of said brake lock device and said door lock device; and
a control mechanism in communication with said controller unit, said control mechanism configured to transmit operational instructions to said controller unit.

2. The system according to claim 1, wherein said brake lock device further comprises a control valve electronically connected to said controller unit and pneumatically connected to said brake line, said control valve configured to open in response to an open signal from said controller unit so as to allow compressed air from said brake line to vent and maintain said brakes in a locked condition until a close signal is received from said controller unit to close said control valve and prevent compressed air from venting to place said brakes in an unlocked condition.

3. The system according to claim 2, wherein said control valve has an inlet and an outlet selectively in fluid communication with said inlet, said inlet pneumatically connected to a brake line outlet pneumatically disposed in said brake line between said supply of compressed air and said brakes, said control valve configured to vent air from said brake line.

4. The system according to claim 3, wherein said control valve further comprises an electric motor operatively connected to a shaft slidably disposed in said control valve to selectively open and close the communication between said inlet and said outlet.

5. The trailer locking device of claim 4, wherein said control valve further comprises one or more-limiting switches to monitor and limit the movement of said shaft in said control valve, said one or more limiting switches electrically connected to said controller unit.

6. The trailer locking device of claim 2, wherein said brake lock device further comprises one or more pressure sensors operatively engaged with said control valve and electronically connected to said controller unit so as to measure the air pressure at said control valve.

7. The system according to claim 6, wherein at least one of said pressure sensors is configured to communicate with said controller unit to open said control valve when the pressure in said brake line drops below a pre-determined level and to maintain said control valve in a closed condition when the pressure in said brake line is above said pre-determined level.

8. The system according to claim 2, wherein said controller unit and said control valve are disposed in a housing.

9. The system according to claim 8, wherein said housing is located in an internal cavity of said trailer.

10. The system according to claim 1, wherein said door lock device comprises an actuator configured to operatively actuate said locking member so as to selectively lock said door, said door lock device configured to be mounted on an interior surface of said trailer, said locking member configured to prevent the opening of said door when said door lock device is in a locked position.

11. The system according to claim 10, wherein said actuator has an actuating rod releasably connected to said locking member and said actuator is releasably mounted on said interior surface of said trailer for selective disengagement of said actuator from said trailer.

12. The system according to claim 11, wherein said actuator is releasably mounted on a back plate member configured to be mounted on said interior surface of said trailer.

13. The system according to claim 10, wherein said trailer has a frame comprising one or more tubular frame members, said locking member configured to be slidably received in a receptor disposed in one of said one or more tubular frame members and cooperatively engaged therewith to prevent the opening of said door until an open command is received from said controller unit.

14. The system according to claim 13, wherein said door lock device further comprises a tubular member mounted to a back plate member, said locking member is a sliding bolt slidably disposed in said tubular member and said receptor is a hole in said tubular frame member sized and configured to receive said sliding bolt.

15. The system according to claim 10, wherein said locking member is configured to operatively engage a receptor attached to a frame member of said trailer.

16. The system according to claim 10, wherein said actuator is an electromechanical linear actuator.

17. The system according to claim 1, wherein said door lock device further comprises a position switch in communication with said controller unit, said position switch configured to detect whether said door is in an open position or a closed position.

18. The system according to claim 17, wherein said position switch is a reed switch.

19. The system according to claim 1 further comprising a communication system for the transmission of signals across a wireless communication network, said communication system comprising a communication device operatively connected to said controller unit.

20. The system according to claim 19, wherein said communication device is a radio.

21. A trailer locking system for securing a trailer having a door and a braking system, said braking system having a brake line configured to pneumatically interconnect a supply of compressed air to one or more air-operated brakes on said trailer, said trailer locking system comprising:
a brake lock device in operative communication with said braking system, said brake lock device configured to selectively place said brakes in a locked condition and prevent movement of said trailer, said brake lock device having a control valve pneumatically connected to said brake line, said control valve configured to open to allow compressed air from said brake line to vent to maintain said brakes in said locked condition and to close to prevent compressed air from venting to place said brakes in an unlocked condition;
a door lock device in operative communication with said door, said door lock device having an actuator configured to operatively actuate a locking member so as to selectively lock said door, said locking member configured to prevent the opening of said door when said door lock device is in said locked position;
a controller unit connected to a power supply and in operative communication with said control valve of said brake lock device and said door lock device, said controller unit having computer circuitry and componentry configured to control the operation of said brake lock device and said door lock device; and
a control mechanism in communication with said controller unit, said control mechanism configured to transmit operational instructions to said controller unit.

22. The system according to claim 21 further comprising a communication system for the transmission of signals across a wireless communication network, said communication system comprising a communication device operatively connected to said controller unit.

23. The system according to claim 21, wherein said control valve further comprises an electric motor operatively connected to a shaft slidably disposed in said control valve to selectively open and close said control valve, said control valve configured to selectively vent air from said brake line.

24. The trailer locking device of claim 23, wherein said control valve further comprises one or more limiting switches to monitor and limit the movement of said shaft in said control valve, said one or more limiting switches electrically connected to said controller unit.

25. The trailer locking device of claim 21, wherein said brake lock device further comprises one or more pressure sensors operatively engaged with said control valve and electronically connected to said controller unit so as to measure the air pressure at said control valve.

26. The system according to claim 25, wherein at least one of said pressure sensors is configured to communicate with said controller unit to open said control valve when the pressure in said brake line drops below a pre-determined level and to maintain said control valve in a closed condition when the pressure in said brake line is above said pre-determined level.

27. The system according to claim 21, wherein said trailer has a frame comprising one or more tubular frame members, said locking member being configured to be slidably received in a receptor disposed in one of said one or more tubular frame members and cooperatively engaged therewith to prevent the opening of said door until an open command is received from said controller unit.

28. The system according to claim 27, wherein said door lock device further comprises a tubular member mounted to a back plate member, said locking member is a sliding bolt slidably disposed in said tubular member and said receptor is a hole in said tubular frame member sized and configured to receive said sliding bolt.

29. The system according to claim 21, wherein said actuator is an electromechanical linear actuator.

30. The system according to claim 21, wherein said door lock device further comprises a position switch in communication with said controller unit, said position switch configured to detect whether said door is in an open position or a closed position.

31. A trailer locking system for securing a trailer having a door and a braking system, said braking system having a brake line configured to pneumatically interconnect a supply of compressed air to one or more air-operated brakes on said trailer, said trailer having a frame comprising one or more tubular frame members, said trailer locking system comprising:
a brake lock device in operative communication with said braking system, said brake lock device configured to selectively place said brakes in a locked condition and prevent movement of said trailer, said brake lock device having a control valve pneumatically connected to said brake line and one or more pressure sensors operatively engaged with said control valve to measure the air pressure at said control valve, said control valve configured to open to allow compressed air from said brake line to vent to maintain said brakes in said locked condition and to close to prevent compressed air from venting to place said brakes in an unlocked condition;
a door lock device in operative communication with said door, said door lock device having an actuator configured to operatively actuate a locking member so as to selectively lock said door, said locking member configured to be slidably received in a receptor disposed in one of said one or more tubular frame members and cooperatively engaged therewith to prevent the opening of said door until an open command is received from said controller unit;
a controller unit connected to a power supply and in operative communication with said control valve of said brake lock device and said door lock device, said controller unit having computer circuitry and componentry configured to control the operation of said brake lock device and said door lock device;
a control mechanism in communication with said controller unit, said control mechanism configured to transmit operational instructions to said controller unit; and
a communication system for the transmission of signals across a wireless communication network, said communication system comprising a communication device operatively connected to said controller unit.

32. The system according to claim 31, wherein at least one of said pressure sensors is configured to communicate with said controller unit to open said control valve when the pressure in said brake line drops below a pre-determined level and to maintain said control valve in a closed condition when the pressure in said brake line is above said pre-determined level.

33. The system according to claim 31, wherein said actuator is an electromechanical linear actuator.

34. The system according to claim 31, wherein said door lock device further comprises a position switch in communication with said controller unit, said position switch configured to detect whether said door is in an open position or a closed position.
